(19) United States
(12) Patent Application Publication
(10) Pub. No.: US 2017/0040589 A1
(43) Pub. Date: Feb. 9, 2017

(54) REGENERATIVE ELECTROLYTIC SOLUTION FOR ENERGY STORAGE DEVICE, ENERGY STORAGE DEVICE REGENERATED USING THE SAME, AND METHOD FOR REGENERATING ENERGY STORAGE DEVICE

(71) Applicant: UBE INDUSTRIES, LTD., Ube-shi (JP)

(72) Inventors: Koji ABE, Ube-shi (JP); Masahide KONDO, Ube-shi (JP)

(73) Assignee: UBE INDUSTRIES, LTD., Ube-shi (JP)

(21) Appl. No.: 15/305,153

(22) PCT Filed: Apr. 20, 2015
(86) PCT No.: PCT/JP2015/061974

§ 371 Date: Oct. 19, 2016

(30) Foreign Application Priority Data
Apr. 21, 2014 (CN) 2014-087730

(51) Int. Cl. H01M 2/36; H01G 11/60; H01G 11/62; H01G 11/64; H01M 2/12; H01M 10/0568; H01M 10/0569; H01M 10/0567; H01M 10/42; H01M 10/0525; H01G 11/22; H01G 11/52

(52) U.S. Cl. CPC H01M 2/36; H01G 11/22; H01G 11/60; H01G 11/62; H01G 11/64; H01G 11/52; H01M 10/0568; H01M 10/0569; H01M 10/0567; H01M 10/4235; H01M 10/0525; H01M 2/1223; H01M 2300/0028

(57) ABSTRACT

The present invention provides a regenerative electrolytic solution for an energy storage device to be refilled when discharge capacity of the energy storage device becomes lower than initial discharge capacity by 1% or more, and the regenerative electrolytic solution has a higher electrolyte concentration and a lower viscosity than an original electrolytic solution. According to the present invention, battery performance can be appropriately improved after the refill.

### TECHNICAL FIELD

The present invention relates to a regenerative electrolytic solution for an energy storage device, an energy storage device regenerated by using the same, and a method for regenerating an energy storage device.

### BACKGROUND ART

In recent years, energy storage devices such as a lithium secondary battery are widely used as power sources for electronic equipment such as cellular phones and notebook personal computers, or as power sources for electric vehicles or power storage. In particular, a battery loaded on a vehicle is used for 5 to 10 years or more in many cases, and since the composition of an electrolytic solution is changed due to decrease of the electrolytic solution caused during the long-term use, there arises a problem in which the battery performance is degraded over time.

Therefore, in the case where the battery life of a secondary battery loaded on a vehicle expires before the vehicle is replaced, there arises a problem in which replacement with a new secondary battery disadvantageously requires some costs. On the other hand, even in the case where the battery life lasts until the vehicle is replaced, if the used secondary battery can be regenerated to become as good as a new one and the regenerated secondary battery can be used for another use, it will be very effective also from the viewpoint of the global environment, and studies are in progress for such purposes.

As a method for refilling an electrolytic solution, for example, Patent Literature 1 discloses a non-aqueous electrolyte secondary battery including a battery container having an openable vent plug, and discloses that the discharge capacity of the battery can be recovered by injecting an electrolytic solution through the vent plug when the discharge capacity is lowered below 90% of initial discharge capacity.

Besides, Patent Literature 2 discloses a non-aqueous electrolyte secondary battery having a sub chamber for holding a non-aqueous electrolytic solution for refill, and discloses that the discharge capacity of the battery can be recovered by refilling the electrolytic solution to the battery when the discharge capacity is lowered below 70% of initial discharge capacity.

Further, Patent Literature 3 discloses that the resistance to high-rate deterioration is improved by supplying a highly concentrated electrolytic solution or supporting electrolyte when the resistance of the battery exceeds a prescribed threshold value.

### PRIOR ART DOCUMENTS

### Patent Documents

Patent Document 1: Japanese Patent Publication No. 2001-210309

Patent Document 2: Japanese Patent Publication No. 2011-108368

Patent Document 3: Japanese Patent Publication No. 2013-098064

### SUMMARY OF THE INVENTION

### Problem to be Solved by the Invention

An object of the present invention is to provide a regenerative electrolytic solution for the above-described energy storage device, the energy storage device regenerated by using the same, and a method for regenerating an energy storage device.

### Means for Solving the Problems

The present inventors studied the above-described techniques of the background art, and have found the following: If the electrolytic solution having the same composition as the original electrolytic solution is used as the electrolytic solution to be reinjected as described in Patent Documents 1 and 2, the battery performance can be recovered to some extent after the refill, but actually, it cannot be said that the recovery is sufficiently satisfactory. It is noted that Patent Document 3 does not describe any specific composition of the electrolytic solution.

Therefore, the present inventors have made earnest studies for solving the above-described problem, resulting in finding the following: In an energy storage device equipped with structure to refill an electrolytic solution, if an electrolytic solution having a different composition from an original non-aqueous electrolytic solution is used as a regenerative electrolytic solution, the battery performance can be appropriately recovered (for example, to an extent beyond that attained by the techniques of the background art) after the refill. Thus, the present invention was accomplished.

That is, the present invention provides the following (1) to (7):

(1) A regenerative electrolytic solution for an energy storage device to be refilled when discharge capacity becomes lower than initial discharge capacity by 1% or more, in which the regenerative electrolytic solution has a higher electrolyte concentration and a lower viscosity than an original electrolytic solution (namely, an electrolytic solution initially injected when production of the battery).

(2) A regenerative electrolytic solution for an energy storage device to be refilled when discharge capacity becomes lower than initial discharge capacity by 1% or more, in which a concentration of an electrolyte is 0.8 M or more and 3.0 M or less, and a content of a chain ester in a solvent contained in the regenerative electrolytic solution is 80% by volume or more.

(3) An energy storage device including a positive electrode, a negative electrode, a separator, and an electrolytic solution containing an electrolyte salt dissolved in a solvent, in which a container of the energy storage device is provided with an openable vent plug through which a gas generated within the energy storage device can be vented and an electrolytic solution can be refilled.

(4) An energy storage device including a positive electrode, a negative electrode, a separator and an electrolytic solution containing an electrolyte salt dissolved in a solvent, in which a container of the energy storage device is provided with structure to hold a regenerative electrolytic solution.

(5) An energy storage device including a positive electrode, a negative electrode, a separator and an electrolytic solution containing an electrolyte salt dissolved in a solvent, in which a container of the energy storage device is provided with a connector and a gas outlet where an injection pipe is attachable and detachable.

(6) A method for regenerating an energy storage device by refilling a regenerative electrolytic solution to the energy storage device, in which the regenerative electrolytic solution having a higher electrolyte concentration and a lower viscosity than an original electrolytic solution contained in the energy storage device is refilled to the energy storage device when discharge capacity becomes lower than initial discharge capacity by 1% or more.

(7) A method for regenerating an energy storage device by refilling a regenerative electrolytic solution to the energy storage device, in which the regenerative electrolytic solution having an electrolyte concentration of 0.8 M or more and 3.0 M or less and having a content of a chain ester in a solvent of 80% by volume or more is refilled to the energy storage device when discharge capacity becomes lower than initial discharge capacity by 1% or more.

### Effect of the Invention

The present invention can provide a regenerative electrolytic solution for an energy storage device, an energy storage device regenerated by using the same, and a method for regenerating an energy storage device.

### BRIEF DESCRIPTION OF DRAWINGS

FIG. 1 is a lateral cross-sectional view of a battery of Example 11.

FIG. 2 is a lateral cross-sectional view of a battery of Example 12.

FIG. 3 is a lateral cross-sectional view of a battery of Example 13.

### DESCRIPTION OF EMBODIMENTS

The present invention relates to a regenerative electrolytic solution for an energy storage device, an energy storage device regenerated by using the same, and a method for regenerating an energy storage device.

[Regeneration Electrolytic Solution]

A regenerative electrolytic solution of the present invention is used for being refilled to the battery, after performing at least one or more charge/discharge cycles, preferably two or more, more preferably five or more, and most preferably ten or more charge/discharge cycles after assembling and sealing a battery. Besides, the regenerative electrolytic solution has a different composition from an electrolytic solution injected first in producing the battery (namely, an original electrolytic solution), and hence is different from a conventionally known electrolytic solution to be reinjected in the assembly of a battery. The number of times of the refill is not especially limited, and the refill is more preferably performed a plurality of times during the use of the energy storage device. Besides, two or more types of regenerative electrolytic solutions having different compositions may be used in one refill. It is noted that the refill of the regenerative electrolytic solution is preferably performed in a battery having been deteriorated in the capacity through charge/discharge cycles or storage in a charged state, and is performed when discharge capacity is lower than initial discharge capacity preferably by 1% or more, more preferably by 3% or more, and particularly preferably by 5% or more. The upper limit of the discharge capacity lowering is preferably 25% or less, more preferably 20% or less, and particularly preferably 15% or less. It is preferable if the regenerative electrolytic solution is refilled in the aforementioned range because thus an effect of improving battery characteristics is increased.

In the present invention, if the composition of an initially injected electrolytic solution is known, the concentration and the viscosity of the electrolyte may be regarded as the concentration and the viscosity of the original electrolytic solution. Alternatively, the concentration and the viscosity of an original electrolytic solution may be obtained as follows: A part of an original electrolytic solution contained in an energy storage device having been charged and discharged is sampled, the sampled electrolytic solution is analyzed for the composition by a known method, and on the basis of a result of the composition analysis, an electrolytic solution having a similar composition is produced to measure the viscosity of the produced electrolytic solution.

[Battery to be Used]

A battery to be used in the present invention may be an aluminum laminated film battery, a prismatic battery or a cylindrical battery, and is not especially limited.

[Means for Refilling Regeneration Electrolytic Solution]

As the means for refilling the regenerative electrolytic solution of the present invention, the following (A) to (C) may be suitably mentioned, but it is noted that the means is not especially limited.

(A) Energy Storage Device Provided with Openable Vent Plug

An energy storage device is produced by housing, in an energy storage device container, an electricity generation part including a positive electrode, a negative electrode and a separator, and an electrolytic solution containing an electrolyte salt dissolved in a solvent, and then sealing the container. The energy storage device container is provided with an openable vent plug, and preferably, the regenerative electrolytic solution is injected into the energy storage device container through the vent plug when refilling the regenerative electrolytic solution.

Besides, the vent plug is more preferably caused to function also as a gas outlet of the energy storage device container. More preferably, a gas present in the energy storage device container is vented by reducing the internal pressure of the energy storage device container through the vent plug, so that the regenerative electrolytic solution can easily permeate in the battery.

The term “openable vent plug” means that the vent plug provided in the energy storage device container can be easily opened with a simple tool such as a spanner and a screwdriver at any time if necessary, and can be easily closed similarly.

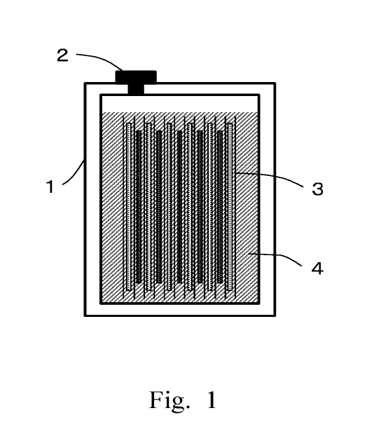

FIG. 1 illustrates a cross-section of an example of this structure. In FIG. 1, a reference sign 1 denotes the energy storage device container, a reference sign 2 denotes the openable vent plug, a reference sign 3 denotes the electricity generation part, and a reference sign 4 denotes the original electrolytic solution.

(B) Energy Storage Device Provided with Sub Chamber for Holding Regeneration Electrolytic Solution

An energy storage device is produced by housing, in an energy storage device container, an electricity generation part including a positive electrode, a negative electrode and a separator, and an electrolytic solution containing an electrolyte salt dissolved in a solvent, and then sealing the container. The energy storage device container is provided with a sub chamber for holding the regenerative electrolytic solution therein, and preferably, the sub chamber communicates with the chamber through an opening, so that the regenerative electrolytic solution can be injected from the sub chamber into the chamber through the opening when refilling the regenerative electrolytic solution. In the sub chamber of the energy storage device container, a sub opening for communicating the sub chamber with the outside is formed, a part of a plug is removably fit in the opening, and another part of the plug penetrates through the sub opening to be exposed to the outside of the contained members. It is noted that an openable vent plug for injecting the regenerative electrolytic solution into the sub chamber may be provided in the sub chamber in addition to the sub opening.

Besides, the vent plug is more preferably caused to function also as a gas outlet of the energy storage device container. More preferably, a gas present in the energy storage device container is vented by reducing the internal pressure of the energy storage device container through the vent plug, so that the regenerative electrolytic solution can easily permeate in the battery. The term “openable vent plug” means that the vent plug provided in the battery container can be easily opened with a simple tool such as a spanner and a screwdriver at any time if necessary, and can be easily closed similarly.

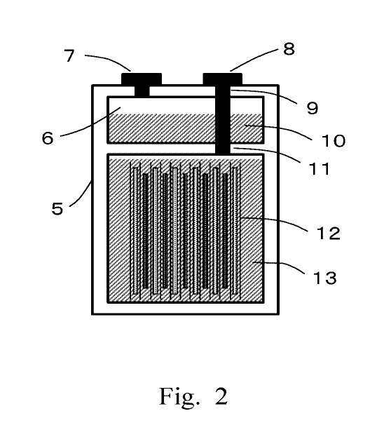

FIG. 2 illustrates a cross-section of an example of this structure. In FIG. 2, a reference sign 5 denotes the energy storage device container, a reference sign 6 denotes the sub chamber, a reference sign 7 denotes the openable vent plug, a reference sign 8 denotes the plug, a reference sign 9 denotes the sub opening, a reference sign 10 denotes the regenerative electrolytic solution, a reference sign 11 denotes the opening, a reference sign 12 denotes the electricity generation part, and a reference sign 13 denotes the original electrolytic solution.

(C) Energy Storage Device Provided with Connector where an Injection Pipe is Attachable and Detachable

An energy storage device is produced by housing, in an energy storage device container, an electricity generation part including a positive electrode, a negative electrode and a separator, and an electrolytic solution containing an electrolyte salt dissolved in a solvent, and then sealing the container. The energy storage device container is provided with a connector where an injection pipe is attachable and detachable, and preferably, the connector is connected to the injection tube so as to inject the regenerative electrolytic solution into the energy storage device container in refilling the regenerative electrolytic solution. As the injection tube, a hose such as a flexible hose is suitably used. As a method for connecting the injection tube and the connector to each other, a one-touch detachable hose coupler such as a cam arm type hose coupler is preferably fit in the connector for use.

The energy storage device container is more preferably provided with a gas outlet. Further preferably, a gas present in the energy storage device container is vented by reducing the internal pressure of the energy storage device container through the vent plug, so that the regenerative electrolytic solution can easily permeate in the battery.

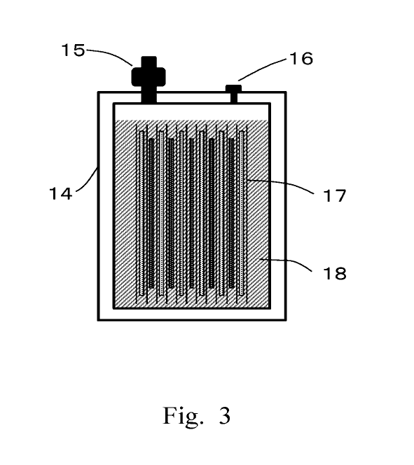

FIG. 3 illustrates a cross-section of an example of this structure. In FIG. 3, a reference sign 14 denotes the energy storage device container, a reference sign 15 denotes the connector, a reference sign 16 denotes the gas outlet, a reference sign 17 denotes the electricity generation part, and a reference sign 18 denotes the original electrolytic solution.

If the gas is vented by reducing the internal pressure of the energy storage device container, a condition for reducing the pressure is preferably controlled so as not to deform the container, and is controlled to preferably −70 kPa or less, more preferably −80 kPa or less and particularly preferably −90 kPa or less. In this case, an effect of improving cycle characteristics at a high temperature is preferably increased. As a method for measuring the pressure, a general pressure gauge such as a Pirani vacuum gauge can be used for the measurement.

The energy storage device is preferably a secondary battery or a capacitor. As the secondary battery, a lithium secondary battery and a nickel hydrogen battery are preferred, and a lithium secondary battery is more preferred. As the capacitor, a lithium ion capacitor and an electric double layer capacitor are preferred, and a lithium ion capacitor is more preferred. Among these energy storage devices, those using a non-aqueous electrolytic solution as the regenerative electrolytic solution are more preferred, and those using a lithium ion as an electrolyte is particularly preferred. As one of these preferred energy storage devices, a lithium secondary battery will now be described in detail, but it is noted that the following description does not especially limit the regenerative electrolytic solution used in the present invention, and an effect of solving the problem of the present invention can be also similarly exhibited in the other energy storage devices.

As a negative electrode active material of the lithium secondary battery, a single one of or a combination of two or more of lithium metals, lithium alloys, carbon materials capable of absorbing/desorbing lithium [such as easily graphitizable carbon, non-graphitizable carbon having a spacing between (002) planes of 0.37 nm or more, and graphite having a spacing between (002) planes of 0.34 nm or less], (simple) tin, tin compounds, (simple) silicon, silicon compounds, lithium titanate compounds such as Li₄Ti₅O₁₂.

Among these, a carbon material having a graphite type crystal structure, such as artificial graphite or natural graphite, is preferably used because a coating film is conspicuously grown through repeated charge/discharge cycles, and hence the battery characteristics are further greatly recovered by the refill of the regenerative non-aqueous electrolytic solution. In particular, in the carbon material having the graphite type crystal structure, a spacing (d₀₀₂) between lattice planes (002) is preferably 0.340 nm (nanometer) or less, more preferably 0.335 to 0.339 nm, and further preferably 0.335 to 0.336 nm.

[Non-Aqueous Electrolytic Solution]

The regenerative non-aqueous electrolytic solution of the present invention is a non-aqueous electrolytic solution that contains an electrolyte salt dissolved in anon-aqueous solvent, and has a higher concentration and a lower viscosity than the original non-aqueous electrolytic solution.

The reason why the battery characteristics can be greatly improved by the regenerative non-aqueous electrolytic solution of the present invention is not all cleared, but is presumed as follows:

After assembling a battery, an original non-aqueous electrolytic solution is reductively decomposed on the surface of a negative electrode through charge/discharge cycles to grow a coating film thereon. Here, if a defect is formed in the coating film on the electrode, the electrolytic solution is newly decomposed in the defect portion, which causes a gas to be generated. If a gas is generated within the battery and a gas passage is formed therein, an electrolyte shortage starts to occur from a portion corresponding to the gas passage, and this probably causes performance degradation such as cycle degradation. Besides, since the electrolyte is consumed due to the formation of the coating film, the absolute amount of the electrolyte is reduced and hence the cycle degradation is further accelerated, and therefore, not only the decomposition of the electrolytic solution is accelerated but also movement of the electrolyte through charge/discharge cycles is liable to become uneven when the charge/discharge cycles are rapidly repeated.

Since the regenerative non-aqueous electrolytic solution of the present invention has a higher electrolyte concentration than the original non-aqueous electrolytic solution, it can effectively work in refilling the electrolyte which has been consumed. Further, since the regenerative non-aqueous electrolytic solution has a lower viscosity than the original non-aqueous electrolytic solution, it is assumed to rapidly permeate in the battery so as to cancel permeation unevenness that has been locally caused, and to regenerate the cycle characteristics. Furthermore, it is more preferable if a specific additive is added to the regenerative non-aqueous electrolytic solution, and the specific additive can strip or restore the coating film accumulated during the use, resulting in improving the battery performance.

[Non-Aqueous Solvent]

Suitable examples of the non-aqueous solvent used in the non-aqueous electrolytic solutions (the original non-aqueous electrolytic solution and the regenerative non-aqueous electrolytic solution) of the present invention include a cyclic carbonate, a chain ester, a lactone and an ether, and the non-aqueous solvent more preferably contains both a cyclic carbonate and a chain ester.

The term “chain ester” is herein used as a concept involving a chain carbonate and a chain carboxylic acid ester.

The cyclic carbonate is preferably at least one selected from ethylene carbonate (EC), propylene carbonate (PC), 1,2-butylene carbonate, 2,3-butylene carbonate and a cyclic carbonate having a fluorine atom.

The cyclic carbonate having a fluorine atom is preferably at least one selected from 4-fluoro-1,3-dioxolane-2-one (FEC) and trans- or cis-4,5-difluoro-1,3-dioxolane-2-one (both of which are hereinafter generically designated as “DFEC”).

The chain ester is preferably a symmetric chain carbonate such as dimethyl carbonate (DMC), diethyl carbonate (DEC), dipropyl carbonate and a dibutyl carbonate; an asymmetric chain carbonate such as methyl ethyl carbonate (MEC), methyl propyl carbonate (MPC), methyl isopropyl carbonate (MIPC), methyl butyl carbonate and ethyl propyl carbonate; or a chain carboxylic acid ester such as pivalic acid ester such as methyl pivalate, ethyl pivalate and propyl pivalate, methyl propionate, ethyl propionate, methyl acetate and ethyl acetate.

A content of the chain ester in the regenerative non-aqueous electrolytic solution is preferably 70% by volume or more, more preferably 80% by volume or more, and particularly preferably 90% by volume or more based on the total volume of the non-aqueous solvent. It is preferable that the content falls in the above-described range because if the content is 70% by volume or more, the viscosity of the non-aqueous electrolytic solution can be lowered so as to improve the permeation in an electrode sheet. A content of the chain ester in the original non-aqueous electrolytic solution is not especially limited, and is generally 70% by volume or less.

If the chain carbonate is used, it is more preferable to contain dimethyl carbonate.

A volume ratio of the dimethyl carbonate in the regenerative non-aqueous electrolytic solution is preferably 51% by volume or more, more preferably 70% by volume or more, and particularly preferably 85% by volume or more based on the total volume of the non-aqueous solvent.

The above-described volume ratio is preferred because the permeation in the electrode sheet is further improved and the effect of improving the cycle characteristics at a high temperature is increased.

It is noted that a volume ratio of the dimethyl carbonate in the original non-aqueous electrolytic solution is not especially limited.

If the chain carboxylic acid ester is used, a pivalic acid ester such as methyl pivalate and ethyl pivalate is more preferably contained, and methyl pivalate is particularly preferred.

A volume ratio of the chain carboxylic acid ester in the regenerative non-aqueous electrolytic solution is preferably 5% by volume or more, more preferably 7% by volume or more, and particularly preferably 10% by volume or more based on the total volume of the non-aqueous solvent.

The above-described volume ratio is preferred because the permeation in the electrode sheet is further improved and the effect of improving the cycle characteristics at a high temperature is increased.

It is noted that a volume ratio of the chain carboxylic acid ester in the original non-aqueous electrolytic solution is not especially limited.

For purpose of further improving thermal stability of the negative electrode, it is preferable to add an additional additive to the non-aqueous electrolytic solution (the original non-aqueous electrolytic solution and the regenerative non-aqueous electrolytic solution) in addition to the electrolyte salt and the non-aqueous solvent. A suitable example of the additional additive includes a cyclic carbonate having an unsaturated bond.

Specific examples of the cyclic carbonate having an unsaturated bond include the following compounds:

At least one cyclic carbonate having an unsaturated bond selected from vinylene carbonate (VC), vinyl ethylene carbonate (VEC), 4-ethynyl-1,3-dioxolane-2-one (EEC) and 2-propynyl 2-oxo-1,3-dioxolane-4-carboxylate. In particular, at least one selected from vinylene carbonate (VC), vinyl ethylene carbonate (VEC) and 4-ethynyl-1,3-dioxolane-2-one (EEC) is preferred.

A content of the cyclic carbonate having an unsaturated bond in the regenerative non-aqueous electrolytic solution is preferably 5 to 30% by mass in the non-aqueous electrolytic solution. If the content exceeds 5% by mass, the coating film is sufficiently restored, and the effect of improving the cycle characteristics at a high temperature is increased. The content is more preferably 5% by mass or more, and further preferably 7% by mass or more in the non-aqueous electrolytic solution, and the upper limit of the content is more preferably 25% by mass or less and further preferably 20% by mass or less.

It is noted that a content of the cyclic carbonate having an unsaturated bond in the original non-aqueous electrolytic solution is not especially limited.

[Electrolyte Salt]

Suitable examples of the electrolyte salt to be used in the present invention include the following lithium salts:

[Li Salt—Class 1]

One or two or more “complex salts of Lewis acid and LiF” selected from LiPF₆, LiBF₄, LiAsF₆, LiSbF₆, LiPF₄ (CF₃)₂, LiPF₃ (C₂F₅)₃, LiPF₃ (CF₃)₃, LiPF₃(iso-C₃F₇)₃ and LiPF₅(iso-C₃F₇) are suitably used, and in particular, LiPF₆, LiBF₄ or LiAsF₆ is preferred, and LiPF₆ or LiBF₄ is more preferred.

[Li Salt—Class 2]

One or two or more “imide or methide lithium salts” selected from LiN(SO₂F)₂, LiN(SO₂CF₃)₂, LiN(SO₂C₂F₅)₂, (CF₂)₂ (SO₂)₂NLi (cyclic), (CF₂)₃(SO₂)₂NLi (cyclic) and LiC(SO₂CF₃)₃ are suitably used, and in particular, LiN(SO₂F)₂, LiN(SO₂CF₃)₂ or LiN(SO₂C₂F₅)₂ is preferred, and LiN(SO₂F)₂ or LiN(SO₂CF₃)₂ is more preferred.

[Li Salt—Class 3]

One or two or more “lithium salts having a S═O group” selected from LiSO₃F, LiCF₃SO₃, CH₃SO₄Li C₂H₅SO₄Li, C₃H₇SO₄Li lithium methanesulfonate pentafluorophosphate (LiPFMSP) and lithium methanesulfonate trifluoroborate (LiTFMSB) are suitably used, and in particular, lithium methanesulfonate pentafluorophosphate (LiPFMSP) or lithium methanesulfonate trifluoroborate (LiTFMSB) is preferred.

[Li Salt—Class 4]

One or two or more “P═O or Cl═O structure-containing lithium salts” selected from LiPO₂F₂, Li₂PO₃F and LiClO₄ are suitably used, and in particular, LiPO₂F₂ or Li₂PO₃F is preferred.

[Li Salt—Class 5]

One or two or more “lithium salts using an oxalate complex as an anion” selected from lithium bis[oxalate-O,O′]borate (LiBOB), lithium difluoro[oxalate-O,O′]borate, lithium difluorobis[oxalate-O,O′]phosphate (LiPFO) and lithium tetrafluoro[oxalate-O,O′]phosphate are suitably used, and in particular, LiBOB or LiPFO is further preferred.

One of or a mixture of two or more of these lithium salts can be used.

Among these lithium salts of Class 1 to Class 5, one or two or more selected from LiPF₆, LiPO₂F₂, Li₂PO₃F, LiBF₄, LiSO₃F, LiN(SO₂F)₂, LiN(SO₂CF₃)₂, LiN(SO₂C₂F₅)₂, CH₃SO₄Li, C₂H₅SO₄Li, lithium bis[oxalate-O,O′]borate (LiBOB), lithium difluorobis[oxalate-O,O′]phosphate (LiPFO), lithium tetrafluoro[oxalate-O,O′]phosphate, lithium methanesulfonate pentafluorophosphate (LiPFMSP) and lithium methanesulfonate trifluoroborate (LiTFMSB) are preferred, and one, two or more selected from LiPF₆, LiPO₂F₂, CH₃SO₄Li, C₂H₅SO₄Li, lithium methanesulfonate pentafluorophosphate (LiPFMSP) and lithium methanesulfonate trifluoroborate (LiTFMSB) are more preferred.

In the original non-aqueous electrolytic solution, the concentration of the lithium salt is generally preferably 0.3 Nor more, more preferably 0.7 M or more and further preferably 1.1 M or more based on the above-described non-aqueous solvent. The upper limit of the concentration is preferably 1.6 M or less, more preferably 1.5 M or less and further preferably 1.4 M or less.

Besides, the concentration of the lithium salt in the regenerative non-aqueous electrolytic solution is preferably higher than the concentration in the original non-aqueous electrolytic solution. After the regenerative non-aqueous electrolytic solution is refilled, the concentration of the lithium salt in the resultant non-aqueous electrolytic solution is preferably higher than the concentration of the lithium salt in the original non-aqueous electrolytic solution.

The concentration of the lithium salt in the regenerative non-aqueous electrolytic solution is generally preferably 0.8 M or more, more preferably 0.9 M or more and further preferably 1.2 M or more based on the above-described non-aqueous solvent. The upper limit of the concentration is preferably 3.0 M or less, more preferably 2.5 M or less, and further preferably 2.2 M or less. It is preferable that the concentration of the lithium salt falls in the above-described range because a Li ion can be thus sufficiently supplemented to the non-aqueous electrolytic solution, and hence the effect of improving the cycle characteristics at a high temperature is increased.

Besides, as a suitable combination of these lithium salts, a combination of LiPF₆ with one or two or more selected from LiPO₂F₂, CH₃SO₄Li, C₂H₅SO₄Li, lithium methanesulfonate pentafluorophosphate (LiPFMSP) and lithium methanesulfonate trifluoroborate (LiTFMSB) is further preferred. In particular, a combination with one or two selected from lithium methanesulfonate pentafluorophosphate (LiPFMSP) and lithium methanesulfonate trifluoroborate (LiTFMSB) is particularly preferred. The reason why lithium methanesulfonate pentafluorophosphate (LiPFMSP) and lithium methanesulfonate trifluoroborate (LiTFMSB) are preferred is not clear but merely speculated as follows: A coating film grows on the surface of an electrode through charge/discharge cycles. LiF contained in the coating film is selectively reacted with a Li salt containing PF₅ or BF₃ (for example, LiPFMSP or LiTFMSB) to dissolve and transform LiF into LiPF₆ or LiBF₄. Thus, LiF contained in the coating film is removed from the surface of the electrode so that the coating film formed early can be removed. It is assumed to be so since, thereafter, a Li salt previously contained in the regenerative electrolytic solution forms a new low-resistant coating film, or an organic additive such as VC forms a new SEI coating film. Two or more types of regenerative electrolytic solutions, that is, a regenerative electrolytic solution containing an additive for removing LiF of a coating film component and a regenerative electrolytic solution containing an additive for forming a low-resistant coating film or a SEI coating film, are preferably separately refilled because thus the effect of improving the battery characteristics is further increased. A ratio of lithium salt excluding LiPF₆ in the non-aqueous solvent is preferably 0.001 M or more because an effect of improving electrochemical characteristics is thus easily exhibited, and is preferably 1.2 M or less because there is little fear of degradation of the effect of improving the electrochemical characteristics. The ratio is preferably 0.01 M or more, particularly preferably 0.03 M or more, and most preferably 0.04 M or more. The upper limit is preferably 1.0 M, more preferably 0.9M or less, particularly preferably 0.8 M or less, and most preferably 0.7 M or less. The concentration of lithium salt excluding LiPF₆ preferably falls in the above-described range because the effect of improving the battery characteristics is thus increased.

[Production of Non-Aqueous Electrolytic Solution]

The non-aqueous electrolytic solution of the present invention can be obtained, for example, by mixing any of the above-described non-aqueous solvents and adding any of the above-described electrolyte salts and additional additives to the resultant.

At this point, a non-aqueous solvent to be used and an additive to be added to the non-aqueous electrolytic solution are preferably purified beforehand to reduce impurities therein as much as possible as long as the productivity is not largely lowered.

From the viewpoint that the battery performance can be appropriately recovered after the refill, a regenerative electrolytic solution having an electrolyte concentration of 0.8 M or more and 3.0 M or less and having a content of a chain ester in a solvent contained in the regenerative electrolytic solution of 80% by volume or more can be used as the regenerative electrolytic solution of the present invention. The regenerative electrolytic solution having such an electrolyte concentration and a solvent composition has characteristics that the electrolyte concentration is equal to or higher than a prescribed concentration and the viscosity is low, and therefore, an effect of recovering the battery performance with above a certain extent after the refill can be exhibited regardless of the composition and the type of the original non-aqueous electrolytic solution. Therefore, the present invention may employ a configuration of using such a regenerative electrolytic solution. In this case, the electrolyte concentration is preferably 0.9 M or more and more preferably 1.2 M or more, and the upper limit is preferably 2.5 M or less and more preferably 2.2 M or less. Besides, the content of the chain ester in the solvent contained in the regenerative electrolytic solution is preferably 85% by volume or more, more preferably 90% by volume or more, and further preferably 100% by volume. The types and contents of an electrolyte salt, a non-aqueous solvent and another additive which can be used properly may be the same as those described above.

### EXAMPLES

### (1) Production of Lithium Ion Battery

[Preparation of Positive Electrode Sheet]

A positive electrode mixture paste was prepared by mixing 94% by mass of LiNi_{1/3}Co_{1/3}Mn_{1/3}O₂ and 3% by mass of acetylene black (a conductive agent), and adding, for mixing, the resultant to a solution precedently obtained by dissolving 3% by mass of polyvinylidene fluoride (a binder) in 1-methyl-2-pyrrolidone. The thus obtained positive electrode mixture paste was applied on an aluminum foil (a current collector), and the resultant was dried and cut into a desired size by pressing, and thus, a positive electrode sheet was prepared.

[Preparation of Negative Electrode Sheet A]

A negative electrode mixture paste was prepared by adding, for mixing, 95% by mass of artificial graphite which has a graphite type crystal structure having a spacing (d₀₀₂) between lattice planes (002) of 0.337 nm, to a solution precedently obtained by dissolving 5% by mass of polyvinylidene fluoride (a binder) in 1-methyl-2-pyrrolidone. The thus obtained negative electrode mixture paste was applied on one surface of a copper foil (a current collector), and the resultant was dried and cut into a desired size by pressing, and thus, a negative electrode sheet A was prepared.

[Preparation of Negative Electrode Sheet B]

A negative electrode mixture paste was prepared by adding, for mixing, 95% by mass of natural graphite which has a spacing (d₀₀₂) between lattice planes (002) of 0.335 nm, to a solution precedently obtained by dissolving 5% by mass of polyvinylidene fluoride (a binder) in 1-methyl-2-pyrrolidone. The thus obtained negative electrode mixture paste was applied on one surface of a copper foil (a current collector), and the resultant was dried and cut into a desired size by pressing, and thus, a negative electrode sheet B was prepared.

[Preparation of Original Non-Aqueous Electrolytic Solution A]

In a solvent obtained by mixing ethylene carbonate (EC), methyl ethyl carbonate (MEC) and dimethyl carbonate (DMC) in a volume ratio of 30:30:40, LiPF₆ was dissolved in a concentration of 1.2 mol/L, and vinylene carbonate (VC) was added to the resultant to 2% by mass based on a total mass of a resultant electrolytic solution, and thus, an original non-aqueous electrolytic solution A was prepared. A kinematic viscosity of the non-aqueous electrolytic solution A measured at room temperature was 2.78 (cSt).

[Preparation of Original Non-Aqueous Electrolytic Solution B]

In a solvent obtained by mixing ethylene carbonate (EC), diethyl carbonate (DEC) and dimethyl carbonate (DMC) in a volume ratio of 30:35:35, LiPF₆ was dissolved in a concentration of 1.0 mol/L, and vinylene carbonate (VC) was added to the resultant to 2% by mass based on a total mass of a resultant electrolytic solution, and thus, an original non-aqueous electrolytic solution B was prepared. A kinematic viscosity of the non-aqueous electrolytic solution B measured at room temperature was 2.62 (cSt).

### Examples 1 to 8 and Comparative Examples 1 and 2

The positive electrode sheet prepared as described above, a microporous polyethylene film separator and the negative electrode sheet A prepared as described above were rolled up to produce an electricity generation part in the shape of a flat roll. Thereafter, the electricity generation part and the original non-aqueous electrolytic solution A were housed in a package of a bag-shaped aluminum laminated film, and the resultant package was sealed.

### Example 9 and Comparative Examples 3 and 4

The positive electrode sheet prepared as described above, a microporous polyethylene film separator and the negative electrode sheet B prepared as described above were rolled up to produce an electricity generation part in the shape of a flat roll. Thereafter, the electricity generation part and the original non-aqueous electrolytic solution A were housed in a package of a bag-shaped aluminum laminated film, and the resultant package was sealed.

### Example 10 and Comparative Examples 5 and 6

An electricity generation part was produced in the same manner as in Example 1. The electricity generation part and the original non-aqueous electrolytic solution B were housed in a package of a bag-shaped aluminum laminated film, and the resultant package was sealed.

[Evaluation of High Temperature Cycle]

<Initial Characteristic>

Each of the batteries produced as described above was used for measuring the initial discharge capacity by performing charging in a thermostatic chamber at 25° C. with a constant current of 1 C and a constant voltage to a termination voltage of 4.2 V for 3 hours, and then discharging with a constant current of 1 C to a termination voltage of 3 V.

<High Temperature Cycle Characteristics>

Each of the batteries produced as described above was subjected to repeated cycles in each of which charging was performed in a thermostatic chamber at 60° C. with a constant current of 3 C and a constant voltage to a termination voltage of 4.2 V for 2 hours and then discharging was performed with a constant current of 3 C to a discharge voltage of 3 V. When the discharge capacity was lowered to 90% of the initial discharge capacity, an edge portion of the package was cut for degassing through the thus formed opening until the pressure was reduced to −90 kPa, and thereafter, the regenerative non-aqueous electrolytic solution (see Table 1 or Table 2) in an amount corresponding to 10% by mass of the injected amount of the original non-aqueous electrolytic solution A or non-aqueous electrolytic solution B was injected with a syringe, and the resultant package was sealed again. In each of Examples 1, 9 and 10, the resultant battery was subjected to the aforementioned cycles again, so as to count the accumulated number of cycles repeated after the injection of the regenerative non-aqueous electrolytic solution until the discharge capacity was lowered below 80% of the initial discharge capacity. In each of Comparative Examples 1, 3 and 5, the accumulated number of cycles repeated from when the discharge capacity was lowered to 90% of the initial discharge capacity until the discharge capacity was further lowered below 80% of the initial discharge capacity without refilling the regenerative electrolytic solution was counted. Besides, a non-aqueous electrolytic solution having the same composition as the original non-aqueous electrolytic solution A (see Table 1) was injected as the regenerative non-aqueous electrolytic solution in each of Comparative Examples 2 and 4, and a non-aqueous electrolytic solution having the same composition as the original non-aqueous electrolytic solution B (see Table 2) was injected in Comparative Example 6.

In Example 2, the battery was evaluated in the same manner as in Example 1 except that the pressure reduction was omitted. In each of Examples 3 to 8, the battery was evaluated in the same manner as in Example 1 except that the regenerative non-aqueous electrolytic solution was changed (see Table 1). The results are shown in Tables 1 and 2.

TABLE 1

| | | | | | | | | | Number of cycles |
|---|---|---|---|---|---|---|---|---|---|
| | | | | | | | | | repeated until |
| | | | | | | | Kinematic | Pressure | capacity retention |
| | | Additional | Additional | Cyclic | Chain | | viscosity | reduction | is below 80% |
| | LiPF6 | salt | salt | carbonate | ester | Additive | (cSt) | (−90 kPa) | (Times) |
| Example 1 | 1.4M | LiPO₂F₂ | none | EC 10 | DMC 90 | none | 2.35 | performed | 437 |
| | | 0.1M | | vol % | vol % | | | | |
| Example 2 | 1.4M | LiPO₂F₂ | none | EC 10 | DMC 90 | none | 2.35 | not | 405 |
| | | 0.1M | | vol % | vol % | | | performed | |
| Example 3 | 1.4M | LiPO₂F₂ | none | EC 20 | DMC 80 | none | 2.77 | performed | 421 |
| | | 0.1M | | vol % | vol % | | | | |
| Example 4 | 1.4M | none | LiPFMSP | EC 10 | DMC 90 | none | 2.45 | performed | 460 |
| | | | 0.1M | vol % | vol % | | | | |
| Example 5 | 0.7M | none | LiPFMSP | EC 10 | DMC 90 | none | 2.72 | performed | 468 |
| | | | 0.7M | vol % | vol % | | | | |
| Example 6 | 1.3M | LiPFO | LiPFMSP | none | DMC 100 | none | 1.89 | performed | 482 |
| | | 0.1M | 0.1M | | vol % | | | | |
| Example 7 | 1.3M | C₂H₅SO₄Li | LiPFMSP | none | DMC 100 | VC 10% | 1.90 | performed | 496 |
| | | 0.1M | 0.1M | | vol % | | | | |
| Example 8 | 1.3M | C₂H₅SO₄Li | LiPFMSP | none | DMC 90 | VC 10% | 2.04 | performed | 505 |
| | | 0.1M | 0.1M | | Methyl pivalate 10 | | | | |
| | | | | | vol % | | | | |
| Comparative | none | none | none | none | none | none | — | — | 358 |
| Example 1 | | | | | | | | | |
| Comparative | 1.2M | none | none | EC 30 | DMC 40 | none | 2.78 | performed | 379 |
| Example 2 | | | | vol % | MEC 30 | | | | |
| | | | | | vol % | | | | |
| Example 9 | 1.4M | LiPO₂F₂ | none | EC 10 | DMC 90 | none | 2.35 | performed | 409 |
| | | 0.1M | | vol % | vol % | | | | |
| Comparative | none | none | none | none | none | none | — | — | 274 |
| Example 3 | | | | | | | | | |
| Comparative | 1.2M | none | none | EC 30 | DMC 40 | none | 2.78 | performed | 302 |
| Example 4 | | | | vol % | MEC 30 | | | | |
| | | | | | vol % | | | | |

TABLE 2

| | | | | | | | | | Number of cycles |
|---|---|---|---|---|---|---|---|---|---|
| | | | | | | | | | repeated until |
| | | | | | | | Kinematic | Pressure | capacity retention |
| | | Additional | Additional | Cyclic | Chain | | viscosity | reduction | is below 80% |
| | LiPF6 | salt | salt | carbonate | ester | Additive | (cSt) | (−90 kPa) | (Times) |
| Example 10 | 1.4M | LiPO₂F₂ | none | EC 10 | DMC 90 | none | 2.35 | performed | 378 |
| | | 0.1M | | vol % | vol % | | | | |
| Comparative | none | none | none | none | none | none | — | — | 297 |
| Example 5 | | | | | | | | | |
| Comparative | 1.0M | none | none | EC 30 | DEC 35 | none | 2.62 | performed | 316 |
| Example 6 | | | | vol % | DMC 35 | | | | |
| | | | | | vol % | | | | |

### Example 11 and Comparative Example 7

In the same manner as in Example 1, an electricity generation part in the form of a layered product was produced. The electricity generation part and the original non-aqueous electrolytic solution A were housed in a battery container provided with the openable vent plug as illustrated in FIG. 1, and the resultant container was sealed to produce a battery.

[Evaluation of High Temperature Cycle]

<Initial Characteristic>

Each of the batteries produced as described above was used for measuring the initial discharge capacity by performing charging in a thermostatic chamber at 25° C. with a constant current of 1 C and a constant voltage to a termination voltage of 4.2 V for 3 hours, and then discharging with a constant current of 1 C to a termination voltage of 3 V.

<High Temperature Cycle Characteristics>

Each of the batteries produced as described above was subjected to repeated cycles in each of which charging was performed in a thermostatic chamber at 60° C. with a constant current of 3 C and a constant voltage to a termination voltage of 4.2 V for 2 hours and then discharging was performed with a constant current of 3 C to a discharge voltage of 3 V. When the discharge capacity was lowered to 90% of the initial discharge capacity, the openable vent plug was opened for degassing therethrough until the pressure was reduced to −90 kPa, and thereafter, the regenerative non-aqueous electrolytic solution (see Table 3) in an amount corresponding to 10% by mass of the injected amount of the original non-aqueous electrolytic solution A was injected through the vent, and the resultant container was sealed again. In Example 11, the resultant battery was subjected to the aforementioned cycles again, so as to count the accumulated number of cycles repeated after the injection of the regenerative non-aqueous electrolytic solution until the discharge capacity was lowered below 80% of the initial discharge capacity. In Comparative Example 7, a non-aqueous electrolytic solution having the same composition as the original non-aqueous electrolytic solution A (see Table 3) was injected as the regenerative non-aqueous electrolytic solution. The results are shown in Table 3.

TABLE 3

| | | | | | | | | | Number of cycles |
|---|---|---|---|---|---|---|---|---|---|
| | | | | | | | | | repeated until |
| | | | | | | | Kinematic | Pressure | capacity retention |
| | | Additional | Additional | Cyclic | Chain | | viscosity | reduction | is below 80% |
| | LiPF6 | salt | salt | carbonate | ester | Additive | (cSt) | (−90 kPa) | (Times) |
| Example 11 | 1.3M | C₂H₅SO₄Li | LiPFMSP | none | DMC 100 | VC 10% | 2.35 | performed | 491 |
| | | 0.1M | 0.1M | | vol % | | | | |
| Comparative | 1.2M | none | none | EC 30 | DMC 40 | none | 2.78 | performed | 401 |
| Example 7 | | | | vol % | MEC 30 | | | | |
| | | | | | vol % | | | | |

### Example 12 and Comparative Example 8

In the same manner as in Example 1, an electricity generation part in the form of a layered product was produced. The electricity generation part was housed in a battery container provided with the sub chamber capable of holding a regenerative electrolytic solution as illustrated in FIG. 2, and thereafter, the original non-aqueous electrolytic solution A was injected through the opening, and the resultant container was sealed with the plug. Next, the openable vent plug provided in the sub chamber was opened, and the regenerative non-aqueous electrolytic solution in an amount corresponding to 10% by mass of the injected amount of the original non-aqueous electrolytic solution A was injected through the vent into the sub chamber.

[Evaluation of High Temperature Cycle]

<Initial Characteristic>

Each of the batteries produced as described above was used for measuring the initial discharge capacity by performing charging in a thermostatic chamber at 25° C. with a constant current of 1 C and a constant voltage to a termination voltage of 4.2 V for 3 hours, and then discharging with a constant current of 1 C to a termination voltage of 3 V.

<High Temperature Cycle Characteristics>

Each of the batteries produced as described above was subjected to repeated cycles in each of which charging was performed in a thermostatic chamber at 60° C. with a constant current of 3 C and a constant voltage to a termination voltage of 4.2 V for 2 hours and then discharging was performed with a constant current of 3 C to a discharge voltage of 3 V. When the discharge capacity was lowered to 90% of the initial discharge capacity, the plug closing the opening for connecting the chamber and the sub chamber was taken out to inject the regenerative non-aqueous electrolytic solution (see Table 4) from the sub chamber into the chamber through the opening. Then, the openable vent plug provided in the sub chamber was opened for degassing therethrough until the pressure was reduced to −90 kPa, and the resultant package was sealed again. In Example 12, the resultant battery was subjected to the aforementioned cycles again, so as to count the accumulated number of cycles repeated after the injection of the regenerative non-aqueous electrolytic solution until the discharge capacity was lowered below 80% of the initial discharge capacity. In Comparative Example 8, a non-aqueous electrolytic solution having the same composition as the original non-aqueous electrolytic solution A (see Table 4) was injected as the regenerative non-aqueous electrolytic solution. The results are shown in Table 4.

TABLE 4

| | | | | | | | | | Number of cycles |
|---|---|---|---|---|---|---|---|---|---|
| | | | | | | | | | repeated until |
| | | | | | | | Kinematic | Pressure | capacity retention |
| | | Additional | Additional | Cyclic | Chain | | viscosity | reduction | is below 80% |
| | LiPF6 | salt | salt | carbonate | ester | Additive | (cSt) | (−90 kPa) | (Times) |
| Example 12 | 1.3M | C₂H₅SO₄Li | LiPFMSP | none | DMC 100 | VC 10% | 1.90 | performed | 488 |
| | | 0.1M | 0.1M | | vol % | | | | |
| Comparative | 1.2M | none | none | EC 30 | DMC 40 | none | 2.78 | performed | 383 |
| Example 8 | | | | vol % | MEC 30 | | | | |
| | | | | | vol % | | | | |

### Example 13 and Comparative Example 9

In the same manner as in Example 1, an electricity generation part in the form of a layered product was produced. The electricity generation part and the original non-aqueous electrolytic solution were housed in a battery container provided with the connector and a gas outlet where an injection pipe is attachable and detachable as illustrated in FIG. 3, and the resultant container was sealed to produce a battery.

[Evaluation of High Temperature Cycle]

<Initial Characteristic>

Each of the batteries produced as described above was used for measuring the initial discharge capacity by performing charging in a thermostatic chamber at 25° C. with a constant current of 1 C and a constant voltage to a termination voltage of 4.2 V for 3 hours, and then discharging with a constant current of 1 C to a termination voltage of 3 V.

<High Temperature Cycle Characteristics>

Each of the batteries produced as described above was subjected to repeated cycles in each of which charging was performed in a thermostatic chamber at 60° C. with a constant current of 3 C and a constant voltage to a termination voltage of 4.2 V for 2 hours and then discharging was performed with a constant current of 3 C to a discharge voltage of 3 V. When the discharge capacity was lowered to 90% of the initial discharge capacity, degassing was performed through the gas outlet until the pressure was reduced to −90 kPa, and then, the injection tube was connected to the connector for injecting the regenerative non-aqueous electrolytic solution (see Table 5) in an amount corresponding to 10% by mass of the injected amount of the original non-aqueous electrolytic solution A, and the injection tube was detached from the connector. In Example 13, the resultant battery was subjected to the aforementioned cycles again, so as to count the accumulated number of cycles repeated after the injection of the regenerative non-aqueous electrolytic solution until the discharge capacity was lowered below 80% of the initial discharge capacity. In Comparative Example 9, a non-aqueous electrolytic solution having the same composition as the original non-aqueous electrolytic solution A (see Table 5) was injected as the regenerative non-aqueous electrolytic solution. The results are shown in Table 5.

TABLE 5

| | | | | | | | | | Number of cycles |
|---|---|---|---|---|---|---|---|---|---|
| | | | | | | | | | repeated until |
| | | | | | | | Kinematic | Pressure | capacity retention |
| | | Additional | Additional | Cyclic | Chain | | viscosity | reduction | is below 80% |
| | LiPF6 | salt | salt | carbonate | ester | Additive | (cSt) | (−90 kPa) | (Times) |
| Example 13 | 1.3M | C₂H₅SO₄Li | LiPFMSP | none | DMC 100 | VC 10% | 1.90 | performed | 513 |
| | | 0.1M | 0.1M | | vol % | | | | |
| Comparative | 1.2M | none | none | EC 30 | DMC 40 | none | 2.78 | performed | 391 |
| Example 9 | | | | vol % | MEC 30 | | | | |
| | | | | | vol % | | | | |

### (2) Production of Lithium Ion Capacitor

[Preparation of Positive Electrode Sheet]

A positive electrode mixture paste was prepared by mixing 85% by mass of an activated carbon powder and 10% by mass of acetylene black (a conductive agent), and adding the resultant to a solution precedently obtained by dissolving 5% by mass of polyvinylidene fluoride (a binder) in 1-methyl-2-pyrrolidone. The thus obtained positive electrode mixture paste was applied on an aluminum foil (a current collector), and the resultant was dried and cut into a desired size by pressing, and thus, a positive electrode sheet was prepared.

[Preparation of Negative Electrode Sheet]

A negative electrode mixture paste was prepared by adding 95% by mass of artificial graphite to a solution precedently obtained by dissolving 5% by mass of polyvinylidene fluoride (a binder) in 1-methyl-2-pyrrolidone. The thus obtained negative electrode mixture paste was applied on one surface of a copper foil (a current collector), and the resultant was dried and cut into a desired size by pressing, and thus, a negative electrode sheet was prepared. Thereafter, a lithium metal foil was caused to adhere to the surface of the negative electrode sheet.

### Example 14 and Comparative Example 10

The positive electrode sheet prepared as described above, a microporous polyethylene film separator and the negative electrode sheet prepared as described above were rolled up to produce an electricity generation part in the shape of a flat roll. Thereafter, the electricity generation part and the original non-aqueous electrolytic solution A were housed in a package of a bag-shaped aluminum laminated film, and the resultant package was sealed.

[Evaluation of High Temperature Cycle]

<Initial Characteristic>

Each of the batteries produced as described above was used for measuring the initial discharge capacity by performing charging in a thermostatic chamber at 25° C. with a constant current of 1 C and a constant voltage to a termination voltage of 4.2 V for 3 hours, and then discharging with a constant current of 1 C to a termination voltage of 3 V.

<High Temperature Cycle Characteristics>

Each of the batteries produced as described above was subjected to repeated cycles in each of which charging was performed in a thermostatic chamber at 60° C. with a constant current of 3 C and a constant voltage to a termination voltage of 4.3 V for 2 hours and then discharging was performed with a constant current of 3 C to a discharge voltage of 3 V. When the discharge capacity was lowered to 90% of the initial discharge capacity, an edge portion of the package was cut for degassing through the thus formed opening until the pressure was reduced to −90 kPa, and thereafter, the regenerative non-aqueous electrolytic solution (see Table 6) in an amount corresponding to 10% by mass of the injected amount of the original non-aqueous electrolytic solution was injected with a syringe, and the resultant package was sealed again. In Example 14, the resultant battery was subjected to the aforementioned cycles again, so as to count the accumulated number of cycles repeated after the injection of the regenerative non-aqueous electrolytic solution until the discharge capacity was lowered below 80% of the initial discharge capacity. In Comparative Example 10, a non-aqueous electrolytic solution having the same composition as the original non-aqueous electrolytic solution (see Table 6) was injected as the regenerative non-aqueous electrolytic solution. The results are shown in Table 6.

TABLE 6

| | | | | | | | | | Number of cycles |
|---|---|---|---|---|---|---|---|---|---|
| | | | | | | | | | repeated until |
| | | | | | | | Kinematic | Pressure | capacity retention |
| | | Additional | Additional | Cyclic | Chain | | viscosity | reduction | is below 80% |
| | LiPF6 | salt | salt | carbonate | ester | Additive | (cSt) | (−90 kPa) | (Times) |
| Example 14 | 1.3M | C₂H₅SO₄Li | LiPFMSP | none | DMC 100 | VC 10% | 1.90 | performed | 588 |
| | | 0.1M | 0.1M | | vol % | | | | |
| Comparative | 1.2M | none | none | EC 30 | DMC 40 | none | 2.78 | performed | 437 |
| Example 10 | | | | vol % | MEC 30 | | | | |
| | | | | | vol % | | | | |

It is understood, based on comparison between Example 1 and Comparative Examples 1 and 2, Example 9 and Comparative Examples 3 and 4, Example 10 and Comparative Examples 5 and 6, Example 11 and Comparative Example 7, Example 12 and Comparative Example 8, Example 13 and Comparative Example 9, and Example 14 and Comparative Example 10, that the cycle characteristics at a high temperature are remarkably improved as compared with the case where the regenerative non-aqueous electrolytic solution of the present invention was not added or the original non-aqueous electrolytic solution was refilled. Besides, it is understood that the cycle characteristics at a high temperature can be much more improved, as compared with Example 1, when a non-aqueous electrolytic solution containing a specific additive or lithium salt is refilled as in Examples 4 to 8. Accordingly, it has been revealed that the effects of the present invention are peculiar to a case where a regenerative non-aqueous electrolytic solution having a higher electrolyte concentration and a lower viscosity than an original non-aqueous electrolytic solution is refilled in an energy storage device equipped with means for refilling the regenerative electrolytic solution.

### INDUSTRIAL APPLICABILITY

An energy storage device excellent in electrochemical characteristics at a high temperature can be obtained by using a regenerative electrolytic solution of the present invention. In particular, if it is used as a regenerative non-aqueous electrolytic solution of an energy storage device loaded on a hybrid electric vehicle, a plug-in hybrid electric vehicle, a battery electric vehicle or the like, an energy storage device having along life time in which the electrochemical characteristics are difficult to lower at a high temperature can be obtained.

### REFERENCE SIGNS LIST

1 . . . energy storage device container
2 . . . vent plug
3 . . . electricity generation part
4 . . . original non-aqueous electrolytic solution
5 . . . energy storage device container
6 . . . sub chamber
7 . . . vent plug
8 . . . plug
9 . . . sub opening
10 . . . regenerative electrolytic solution
11 . . . opening
12 . . . electricity generation part
13 . . . original electrolytic solution
14 . . . energy storage device container
15 . . . connector
16 . . . gas outlet
17 . . . electricity generation part
18 . . . original electrolytic solution

1-11. (canceled)

12: An energy storage device comprising, in a container,
a positive electrode, a negative electrode, and a regenerative electrolytic solution comprising an electrolyte salt dissolved in a solvent, wherein
the energy storage device comprises a structure adapted to refill the electrolytic solution,
an original electrolytic solution was replaced with the regenerative electrolytic solution when a discharge capacity became lower than an initial discharge capacity by 1% or more, and
the regenerative electrolytic solution has a higher electrolyte concentration and a lower viscosity than the original electrolytic solution.

13: The energy storage device according to claim 12, wherein the container of the energy storage device has an openable vent plug.

14: The energy storage device according to claim 12, wherein the container of the energy storage device has a sub chamber for holding the regenerative electrolytic solution.

15: The energy storage device according to claim 12, wherein the container of the energy storage device has a bag-shaped aluminum laminated film as a package.

16: The energy storage device according to claim 13, wherein a pressure within the container for the energy storage device is reduced to −70 kPa or less.

17: A method for regenerating an energy storage device, comprising refilling the energy storage device with a regenerative electrolytic solution when a discharge capacity becomes lower than an initial discharge capacity by 1% or more,
wherein the regenerative electrolytic solution has a higher electrolyte concentration and a lower viscosity than an original electrolytic solution contained in the energy storage device.

18: A method for regenerating an energy storage device, comprising refilling the energy storage device with a regenerative electrolytic solution when a discharge capacity becomes lower than an initial discharge capacity by 1% or more,
wherein the regenerative electrolytic solution comprises an electrolyte in a concentration of 0.8 M to 3.0 M, and has a content of a chain ester of 80% by volume or more in a solvent.

19: The method of claim 17, wherein the energy storage device is refilled with the regenerative electrolytic solution when the discharge capacity becomes lower than the initial discharge capacity by 1% to 25%.

20: The method of claim 17, wherein the electrolyte concentration in the regenerative electrolytic solution is 0.8 M to 2.5 M.

21: The method of claim 17, wherein the regenerative electrolytic solution comprises:
LiPF₆, and
at least one selected from the group consisting of LiPO₂F₂, CH₃SO₄Li, C₂H₅SO₄Li, lithium methanesulfonate pentafluorophosphate (LiPFMSP) and lithium methanesulfonate trifluoroborate (LiTFMSB).

22: The method of claim 17, wherein the regenerative electrolytic solution comprises at least one selected from the group consisting of LiPO₂F₂, CH₃SO₄Li, C₂H₅SO₄Li, lithium methanesulfonate pentafluorophosphate (LiPFMSP) and lithium methanesulfonate trifluoroborate (LiTFMSB) in a concentration of 0.001 M to 1.2 M.

23: The method of claim 17, wherein the regenerative electrolytic solution comprises a chain ester in a content of 80% by volume or more.

24: The method of claim 23, wherein the chain ester comprises dimethyl carbonate.

25: The method of claim 17, wherein the regenerative electrolytic solution comprises a cyclic carbonate having an unsaturated bond in a content of 5 to 30% by mass.

26: The method of claim 25, wherein the cyclic carbonate having an unsaturated bond is at least one selected from the group consisting of vinylene carbonate (VC), vinyl ethylene carbonate (VEC) and 4-ethynyl-1,3-dioxolane-2-one (EEC).

27: The method of claim 17, wherein the regenerative electrolytic solution is a non-aqueous electrolytic solution.
